(19) United States
(12) Patent Application Publication
(10) Pub. No.: US 2026/0343469 A1
(43) Pub. Date: Oct. 29, 2026

(54) Method, Device and Computer Program Product for Wireless Communication

(71) Applicant: ZTE CORPORATION, Shenzhen, Guangdong (CN)

(72) Inventors: YING HUANG, Shenzhen (CN); Lin CHEN, Shenzhen (CN)

(21) Appl. No.: 19/111,492

(22) PCT Filed: Apr. 7, 2023
(86) PCT No.: PCT/CN2023/086950

§ 371 Date: Mar. 13, 2025

(51) Int. Cl. H04W 64/00

(52) U.S. Cl. CPC H04W 64/00

(57) ABSTRACT

A wireless communication method is disclosed. The method comprises receiving, by a mobile wireless communication node from a communication node, configuration information of the mobile wireless communication node; and broadcasting, by the mobile wireless communication node, location information according to the configuration information.

This document is directed generally to wireless communications, and in particular to 5^{th} generation (5G) communications or 6^{th} generation (6G) communications.

Integrated Access and Backhaul (IAB) supports wireless backhauling via NR (new radio) enabling flexible and dense deployment of NR cells while reducing the need for wireline transport infrastructure. However, the migration of a IAB node is still a topic to be discussed.

This document relates to methods, systems, and devices for IAB.

One aspect of the present disclosure relates to a wireless communication method. In an embodiment, the wireless communication method includes: receiving, by a mobile wireless communication node from a communication node, configuration information of the mobile wireless communication node; and broadcasting, by the mobile wireless communication node, location information according to the configuration information.

Another aspect of the present disclosure relates to a communication method. In an embodiment, the communication method includes: transmitting, by a communication node to a mobile wireless communication node, configuration information of the mobile wireless communication node to allow the mobile wireless communication node to broadcasting location information according to the configuration information.

Another aspect of the present disclosure relates to a communication method. In an embodiment, the communication method includes: transmitting, by a donor node of a mobile wireless communication node, configuration information of the mobile wireless communication node to an Access and Mobility Management Function, AMF.

Another aspect of the present disclosure relates to a communication method. In an embodiment, the communication method includes: transmitting, by a donor node of a mobile wireless communication node, configuration information of the mobile wireless communication node to one or more neighbor communication nodes.

Another aspect of the present disclosure relates to a wireless communication node. In an embodiment, the wireless communication node includes a communication unit and a processor. The processor is configured to: receive, via the communication unit from a communication node, configuration information of the mobile wireless communication node; and broadcast, via the communication unit, location information according to the configuration information.

Another aspect of the present disclosure relates to a communication node. In an embodiment, the communication node includes a communication unit and a processor. The processor is configured to: transmit, via the communication unit to a mobile wireless communication node, configuration information of the mobile wireless communication node to allow the mobile wireless communication node to broadcasting location information according to the configuration information.

Various embodiments may preferably implement the following features:

Preferably, the configuration information comprises at least one of:
Tracking Area Code, TAC, configuration information; or
Radio Access Network Area Code, RANAC, configuration information.

Preferably, the TAC configuration information comprises at least one of:
one or more TACs,
a mobile IAB indication,
a TAC for a mobile IAB cell,
a dedicated TAC,
a dedicated TAC indication,
geographic location information, or
cell information.

Preferably, the RANAC configuration information comprises at least one of:
one or more RANACs,
a mobile IAB indication,
an RANAC for a mobile IAB cell,
a dedicated RANAC,
a dedicated RANAC indication,
geographic location information, or
cell information.

Preferably, the cell information comprises at least one of: a node identifier for the donor node connected with a parent node of the mobile wireless communication node or a cell identifier for a parent cell of the mobile wireless communication node.

Preferably, the communication node is a parent communication node of the mobile wireless communication node or a donor node of the wireless communication node.

Preferably, the communication node is a parent communication node of the mobile wireless communication node and receives the configuration information from a donor node of the mobile wireless communication node; or wherein the wireless communication node is a donor of the mobile wireless communication node and transmits the configuration information to a parent communication node of the mobile wireless communication node.

Preferably, the communication node is a donor node of the mobile wireless communication node, and the donor node transmits the configuration information to an Access and Mobility Management Function, AMF.

Preferably, the wireless communication node is a donor node of the mobile wireless communication node, and the donor wireless communication node transmits the configuration information to one or more neighbor communication nodes.

The present disclosure relates to a computer program product comprising a computer-readable program medium code stored thereupon, the code, when executed by a processor, causing the processor to implement a wireless communication method recited in any one of foregoing methods.

The exemplary embodiments disclosed herein are directed to providing features that will become readily apparent by reference to the following description when taken in conjunction with the accompany drawings. In accordance with various embodiments, exemplary systems, methods, devices and computer program products are disclosed herein. It is understood, however, that these embodiments are presented by way of example and not limitation, and it will be apparent to those of ordinary skill in the art who read the present disclosure that various modifications to the disclosed embodiments can be made while remaining within the scope of the present disclosure.

Thus, the present disclosure is not limited to the exemplary embodiments and applications described and illustrated herein. Additionally, the specific order and/or hierarchy of steps in the methods disclosed herein are merely exemplary approaches. Based upon design preferences, the specific order or hierarchy of steps of the disclosed methods or processes can be re-arranged while remaining within the scope of the present disclosure. Thus, those of ordinary skill in the art will understand that the methods and techniques disclosed herein present various steps or acts in a sample order, and the present disclosure is not limited to the specific order or hierarchy presented unless expressly stated otherwise.

The above and other aspects and their implementations are described in greater detail in the drawings, the descriptions, and the claims.

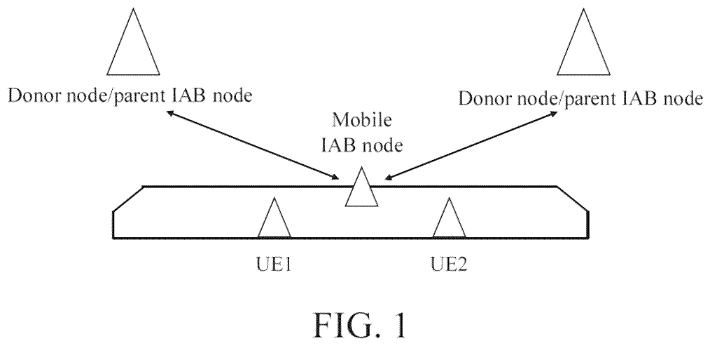

FIG. 1 shows a mobile IAB scenario according to an embodiment of the present disclosure.

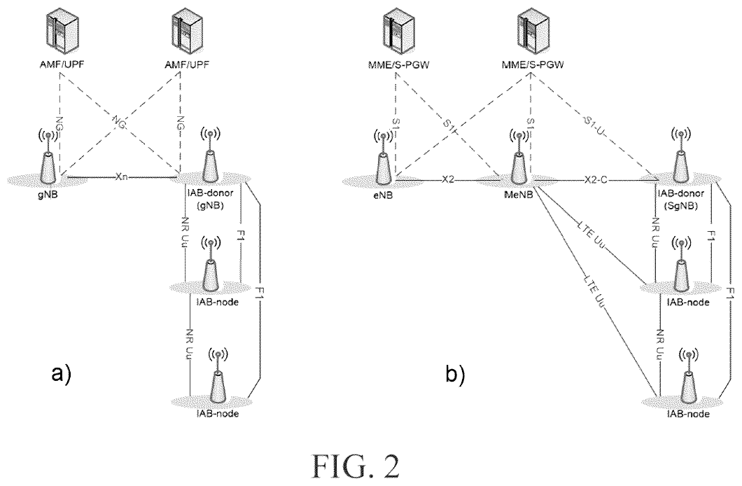

FIGS. 2a) and 2b) show an IAB architecture according to an embodiment of the present disclosure.

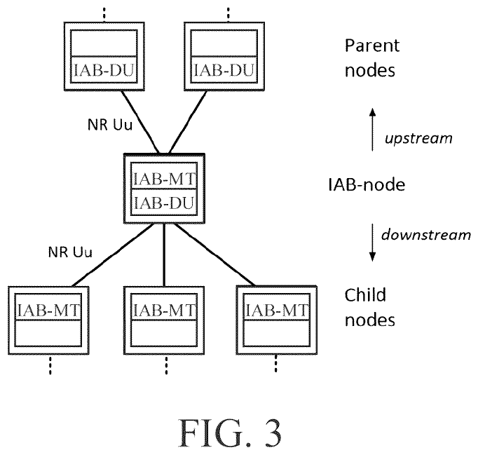

FIG. 3 shows a parent-node and child-node relationship for IAB-node according to an embodiment of the present disclosure.

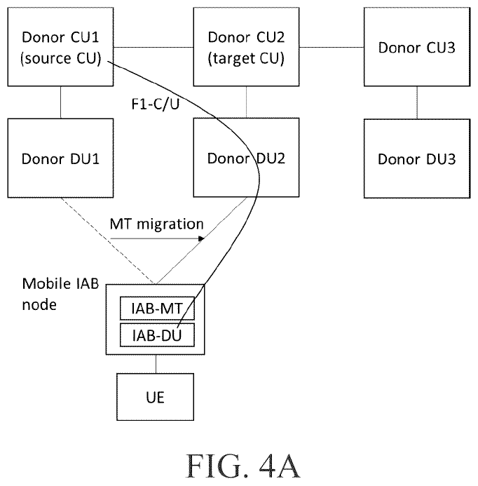

FIG. 4A to 4C show inter-donor migration including partial migration and full migration according to an embodiment of the present disclosure.

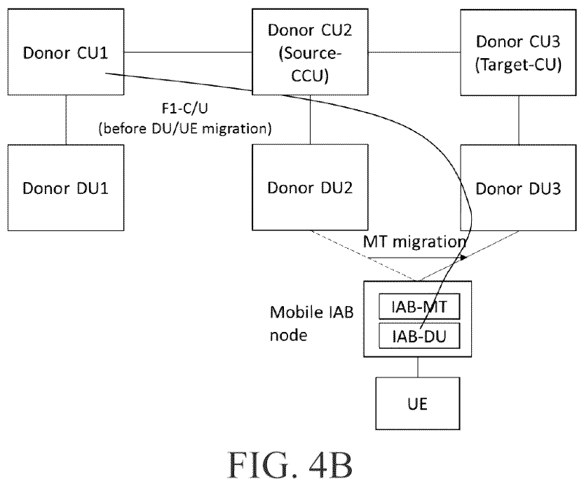

FIG. 5 shows an example of a schematic diagram of a wireless terminal according to an embodiment of the present disclosure.

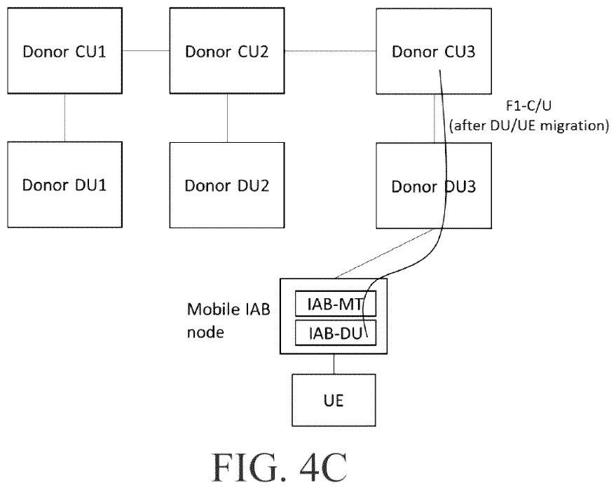

FIG. 6 shows an example of a schematic diagram of a network node according to an embodiment of the present disclosure.

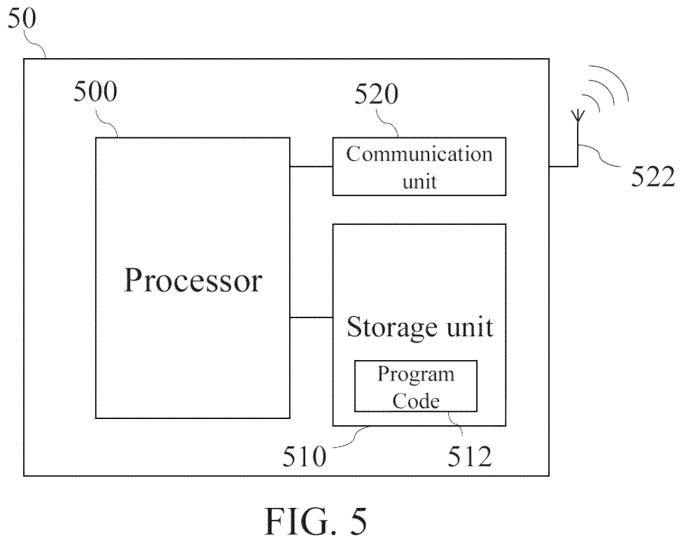

FIGS. 7 to 10 show flowcharts of methods according to some embodiments of the present disclosure.

In some embodiments, an Intra-donor CU (control unit) migration procedure may have both the source and the target parent node being served by the same IAB-donor-CU. Inter-donor CU partial migration may have a migrating IAB node being static.

In some embodiments of the present disclosure, an inter-donor migration in a mobile IAB use-case is discussed.

FIG. 1 shows a mobile IAB scenario. In a mobile IAB use case, IAB nodes may be mounted in vehicles and can provide 5G coverage and/or capacity enhancement to onboard and/or surrounding UEs (user equipment(s)). In FIG. 1, a train is shown as an exemplary vehicle, but the invention also applies to other means of transportation.

In some embodiments, IAB may enable wireless relaying in NG-RAN (Next Generation Radio Access Network). The relaying node, referred to as IAB-node, supports access and backhauling via NR. The terminating node of NR backhauling on the network side is referred to as the IAB-donor, which represents a gNB (gNodeB) with an additional functionality to support IAB. Backhauling can occur via a single or via multiple hops. The IAB architecture is shown in FIGS. 2a) and 2b).

In some embodiments, the IAB-node may support a gNB-DU (distributed unit) functionality, to terminate the NR access interface to UEs and next-hop IAB-nodes, and to terminate the F1 protocol to the gNB-CU (central unit) functionality, on the IAB-donor. The gNB-DU functionality on the IAB-node is also referred to as IAB-DU.

In some embodiments, in addition to the gNB-DU functionality, the IAB-node may also support a subset of the UE functionality referred to as IAB-MT(Mobile Termination), which includes, e.g., the physical layer, the layer-2, the RRC (Radio Resource Control) and NAS (Non-access stratum) functionality to connect to the gNB-DU of another IAB-node or the IAB-donor, to connect to the gNB-CU on the IAB-donor, and to the core network.

In some embodiments, the IAB-node can access the network using either SA(Standalone)-mode or EN-DC (E-UTRAN New Radio-Dual Connectivity). In EN-DC, the IAB-node also connects via the E-UTRA to a MeNB (master eNodeB), and the IAB-donor terminates X2-C as SgNB (secondary gNodeB).

In some embodiments, all IAB-nodes that are connected to an IAB-donor via one or multiple hops form a directed acyclic graph (DAG) topology with the IAB-donor at its root (see FIG. 3). In this DAG topology, the neighbor node on the IAB-DU's interface is referred to as child node and the neighbor node on the IAB-MT's interface is referred to as parent node. The direction toward the child node is further referred to as downstream while the direction toward the parent node is referred to as upstream. The IAB-donor performs centralized resource, topology and route management for the IAB topology.

In the paragraphs below, a partial migration and a full migration in a mobile IAB use case will be discussed.

According to an embodiment, in the partial migration, the migration of an IAB-MT to a parent node underneath a different IAB-donor-CU may be performed while the co-located IAB-DU and descendant IAB-node(s), if any, are not migrated (i.e., terminated at the initial IAB-donor-CU). According to an embodiment, in the full migration, the migrating IAB node (i.e., the mobile IAB node in mobile IAB scenario) and the descendant IAB node(s) (if any) may be migrated (both RRC and F1 connections) to the 2nd IAB-donor-CU from 1st IAB-donor-CU.

An F1-terminating IAB-donor may refer to the IAB-donor that terminates F1 for the IAB-node, which can also be referred to as the DU's donor.

In an embodiment, there may be two logical DUs in the mobile IAB node. The two logical DUs in the mobile IAB node can be called source logical DU and target logical DU, or logical DU1 and logical DU2.

FIGS. 4A to 4C show examples of inter-donor migrations including the partial migration and the full migration. As illustrated in FIG. 4A, a partial migration is performed. The IAB-MT migrates from the donor DU1 which belongs to the donor CUI to the donor DU2 which belongs to the donor CU2. However, the IAB-DU maintains its F1 connection with the donor CU1 and the UE context remains in the donor CU1. The F1 control plane and/or user plane traffic between the donor CUI and the IAB-DU is transmitted via the donor DU2.

As illustrated in FIG. 4B, a partial migration is performed. The IAB-MT migrates from the donor DU2 which belongs to the donor CU2 to the donor DU3 which belongs to the donor CU3. However, the IAB-DU maintains its F1 connection with the donor CU1 and the UE context remains in the donor CU1. The F1 control plane and/or user plane traffic between the donor CU1 and the IAB-DU is transmitted via the donor DU3.

As illustrated in FIG. 4C, a full migration is performed. The MT and the DU are migrated to the same donor. The IAB-DU migrates from the donor CU1 to the donor CU3. The UE is handed over from the donor CU1 to the donor CU3. The F1 control plane and/or user plane traffic between the donor CU3 and the IAB-DU is transmitted via the donor DU3.

In the paragraphs below, details of the present disclosure will be provided in different embodiments, but the present disclosure is not limited to the embodiments below.

### Embodiment 1

In the mobile IAB use case, the mobile IAB node may be mounted in vehicles and moves with the vehicle. The mobile IAB node may perform a partial migration or a full migration along with the movement of the mobile IAB-MT. In this situation, the TAC (Tracking Area Code)/RANAC (RAN-based Notification Area Code) broadcast by the mobile IAB-DU cell may need to change (or updated) to reflect the actual location (e.g., geographic location) of the mobile IAB node after the mobile IAB node moves.

In an embodiment, the mobile IAB-DU obtains the TAC for broadcasting as below. Note that in the present disclosure, the TAC is taken as an example, and the mobile IAB-DU may obtain the RANAC for broadcasting in a similar manner.

Step 1: the mobile IAB node's parent IAB node broadcasts TAC configuration information (e.g., updated TAC configuration information) for the mobile IAB node via system information. The TAC configuration information includes at least one of the following: one or more TACs, a mobile IAB indication, a TAC for mobile IAB cell, a dedicated TAC, or a dedicated TAC indication.

In an embodiment, before the mobile IAB node's parent IAB node broadcasts TAC configuration information for the mobile IAB node via system information, the mobile IAB node's parent IAB node may receive the TAC configuration information (e.g., updated TAC configuration information) for the mobile IAB node from the IAB donor, e.g., via an F1 message.

Step 2: The mobile IAB-MT receives the TAC configuration information (e.g., updated TAC configuration information) for a mobile IAB cell from the system information and delivers it to the co-located DU.

Step 3: The mobile IAB-DU sends its TAC configuration (e.g., updated TAC configuration) to its connected IAB donor. The TAC configuration may include at least the TAC (e.g., updated TAC) received from the mobile IAB node's parent IAB node via the system information.

Step 4: The mobile IAB-DU broadcasts the TAC (e.g., updated TAC) received from the mobile IAB node's parent IAB node via the system information.

### Embodiment 2

Step 1: The mobile IAB-DU's donor (i.e., the IAB donor which has an F1 connection with the mobile IAB-DU) sends the TAC configuration information (e.g., updated TAC configuration information) to the mobile IAB node, e.g., via an F1 message. The TAC configuration information may include at least one of the following: one or more TACs, a mobile IAB indication, a TAC for the mobile IAB cell, a dedicated TAC, a dedicated TAC indication, geographic location information, or cell information. The cell information may include a gNB ID (identifier) or cell ID (e.g., PCI (Physical Cell ID) or NCGI (New Radio Cell Global Identity)) of the mobile IAB-MT's parent cell, i.e., the cell which belongs to the mobile IAB-MT's parent node and serves the mobile IAB-MT.
Step 2: The mobile IAB-DU broadcasts the TAC (e.g., updated TAC) received from the mobile IAB-DU's donor via an F1 message.

### Embodiment 3

In an embodiment, the AMF (access and mobility management function) may need to know the TAC supported in the gNB, so that the AMF can send paging message for UE to appropriate gNBs. In an embodiment, the AMF obtains the TAC for a mobile IAB cell as follows. In an embodiment, the mobile IAB's donor (e.g., the mobile IAB-MT's donor or the mobile IAB-DU's donor) sends the TAC configuration for the mobile IAB cell to the AMF via a NG message. The TAC configuration for the mobile IAB cell includes at least one of the following: one or more TACs, a mobile IAB indication, a TAC for mobile IAB cell, a dedicated TAC, or a dedicated TAC indication.

### Embodiment 4

In an embodiment, the gNB may need to know the TAC supported in neighbor gNBs, so that the gNB can send a RAN paging message for UE to appropriate neighbor gNBs. In an embodiment, neighbor gNBs obtain the TAC for a mobile IAB cell as below.

In an embodiment, the mobile IAB's donor (e.g., the mobile IAB-MT's donor or the mobile IAB-DU's donor) sends the TAC configuration for the mobile IAB cell to neighbor gNBs, e.g., via a Xn message. The TAC configuration for mobile IAB cell includes at least one of the following: one or more TACs, a mobile IAB indication, a TAC for mobile IAB cell, a dedicated TAC, or a dedicated TAC indication.

### Embodiment 5—Inter-Donor Backhaul RLF Recovery

An embodiment of the present disclosure addresses the problem that, during an inter-donor backhaul RLF recovery, how the initial IAB donor could identify the recovery IAB-node during the IPsec (Internet Protocol Security) connection establishment phase.

### Option 1:

Step 1: the recovery IAB-node sends an RRC message to the new IAB donor. An IAB node indication is included in the RRC message, e.g., an RRC reestablishment request or an RRC reestablishment request complete message.
Step 2: the new IAB donor determines that the node involved in the RRC reestablishment procedure is an IAB node.
Step 3: the new IAB node sends the F1-C (control plane) IP (internet protocol) address(es) of the recovery IAB-node to the initial IAB donor via Xn, e.g., via an Xn retrieve the UE context request message.

### Option 2:

The new IAB donor sends the F1-C IP address(es) of the recovery IAB-node to the initial IAB donor via Xn, e.g., via a UE context release message or a new XnAP message. Optionally, the new IAB donor may send the F1-C IP address(es) to the initial IAB donor after receiving the Xn retrieve UE context response message.

FIG. 5 relates to a schematic diagram of a wireless terminal 50 according to an embodiment of the present disclosure. The wireless terminal 50 may be a user equipment (UE), a mobile phone, a laptop, a tablet computer, an electronic book or a portable computer system and is not limited herein. The wireless terminal 50 may include a processor 500 such as a microprocessor or Application Specific Integrated Circuit (ASIC), a storage unit 510 and a communication unit 520. The storage unit 510 may be any data storage device that stores a program code 512, which is accessed and executed by the processor 500. Embodiments of the storage unit 512 include but are not limited to a subscriber identity module (SIM), read-only memory (ROM), flash memory, random-access memory (RAM), hard-disk, and optical data storage device. The communication unit 520 may a transceiver and is used to transmit and receive signals (e.g., messages or packets) according to processing results of the processor 500. In an embodiment, the communication unit 520 transmits and receives the signals via at least one antenna 522 shown in FIG. 5.

In an embodiment, the storage unit 510 and the program code 512 may be omitted and the processor 500 may include a storage unit with stored program code.

The processor 500 may implement any one of the steps in exemplified embodiments on the wireless terminal 50, e.g., by executing the program code 512.

The communication unit 520 may be a transceiver. The communication unit 520 may as an alternative or in addition be combining a transmitting unit and a receiving unit configured to transmit and to receive, respectively, signals to and from a network node.

FIG. 6 relates to a schematic diagram of a network node 60 according to an embodiment of the present disclosure. The network node 60 may be a satellite, a base station (BS), a network entity, a Mobility Management Entity (MME), Serving Gateway (S-GW), Packet Data Network (PDN) Gateway (P-GW), a radio access network (RAN) node, a next generation RAN (NG-RAN) node, a gNB, an eNB, a gNB central unit (gNB-CU), a gNB distributed unit (gNB-DU) a data network, a core network, a Radio Network Controller (RNC), a mobile IAB node, a parent IAB node, or a IAB donor and is not limited herein. In addition, the network node 60 may comprise (perform) at least one network function such as an access and mobility management function (AMF), a session management function (SMF), a user place function (UPF), a policy control function (PCF), an application function (AF), etc. The network node 60 may include a processor 600 such as a microprocessor or ASIC, a storage unit 610 and a communication unit 620. The storage unit 610 may be any data storage device that stores a program code 612, which is accessed and executed by the processor 600. Examples of the storage unit 612 include but are not limited to a SIM, ROM, flash memory, RAM, hard-disk, and optical data storage device. The communication unit 620 may be a transceiver and is used to transmit and receive signals (e.g., messages or packets) according to processing results of the processor 600. In an example, the communication unit 620 transmits and receives the signals via at least one antenna 622 shown in FIG. 6. In another example, network node 60 may not have antenna, and the communication unit 620 transmits and receives the signals via wires.

In an embodiment, the storage unit 610 and the program code 612 may be omitted. The processor 600 may include a storage unit with stored program code.

The processor 600 may implement any steps described in exemplified embodiments on the network node 60, e.g., via executing the program code 612. In an embodiment, the network node 60 may be used to implement the mobile IAB node, the parent IAB node, or the IAB donor described above.

The communication unit 620 may be a transceiver. The communication unit 620 may as an alternative or in addition be combining a transmitting unit and a receiving unit configured to transmit and to receive, respectively, signals to and from a node (e.g., a mobile IAB node or a parent IAB node).

A wireless communication method is also provided according to an embodiment of the present disclosure. In an embodiment, the wireless communication method may be performed by using a wireless communication node (e.g., a mobile IAB node). In an embodiment, the wireless communication node may be implemented by using the network node 60 described above, but is not limited thereto.

Referring to FIG. 7, in an embodiment, the wireless communication method includes: receiving, by a mobile wireless communication node (e.g., a mobile IAB node) from a communication node (e.g., a parent IAB node or a IAB donor), configuration information of the mobile wireless communication node; and broadcasting, by the mobile wireless communication node, location information according to the configuration information.

Details in this regard can be ascertained with reference to the paragraphs above, and will not be repeated herein.

A wireless communication method is also provided according to an embodiment of the present disclosure. In an embodiment, the wireless communication method may be performed by using a wireless communication node (e.g., a parent IAB node or a IAB donor). In an embodiment, the wireless communication node may be implemented by using the network node 60 described above, but is not limited thereto.

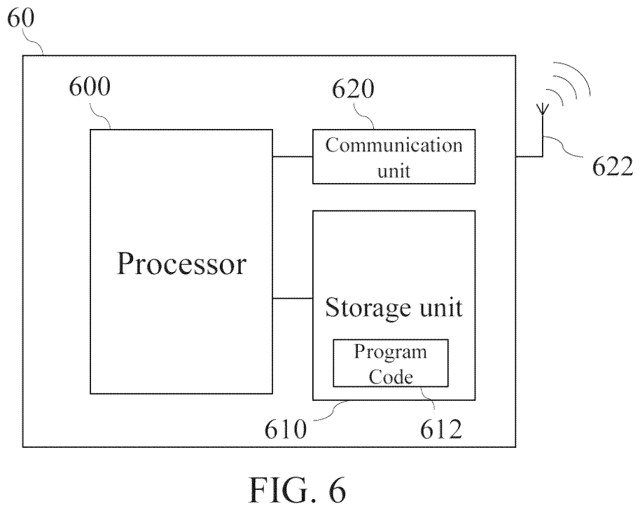

Referring to FIG. 8, in an embodiment, the communication method includes transmitting, by a communication node (e.g., a parent IAB node or a IAB donor) to a mobile wireless communication node (e.g., a mobile IAB node), configuration information of the mobile wireless communication node to allow the mobile wireless communication node to broadcasting location information according to the configuration information.

Details in this regard can be ascertained with reference to the paragraphs above, and will not be repeated herein.

A wireless communication method is also provided according to an embodiment of the present disclosure. In an embodiment, the wireless communication method may be performed by using a wireless communication node (e.g., a IAB donor). In an embodiment, the wireless communication node may be implemented by using the network node 60 described above, but is not limited thereto.

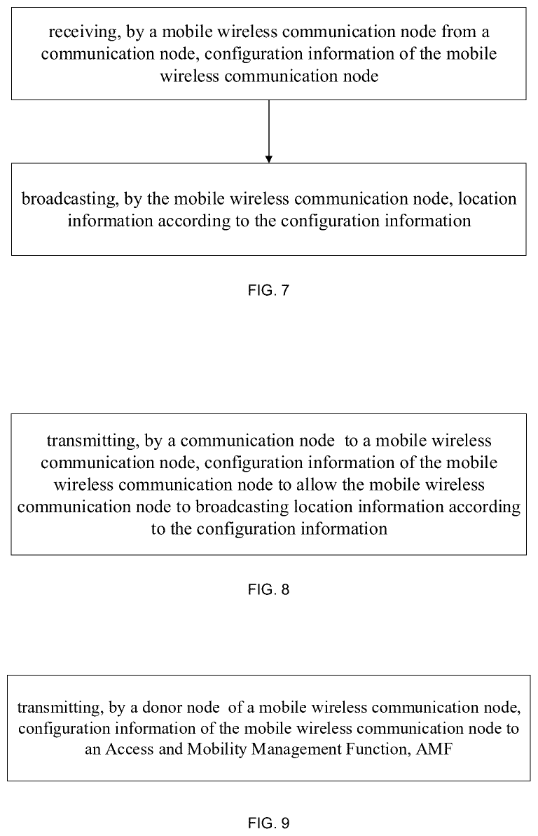

Referring to FIG. 9, in an embodiment, the communication method includes transmitting, by a donor node (e.g., a IAB donor) of a mobile wireless communication node (e.g., a mobile IAB node), configuration information of the mobile wireless communication node to an Access and Mobility Management Function, AMF.

Details in this regard can be ascertained with reference to the paragraphs above, and will not be repeated herein.

A wireless communication method is also provided according to an embodiment of the present disclosure. In an embodiment, the wireless communication method may be performed by using a wireless communication node (e.g., a IAB donor). In an embodiment, the wireless communication node may be implemented by using the network node 60 described above, but is not limited thereto.

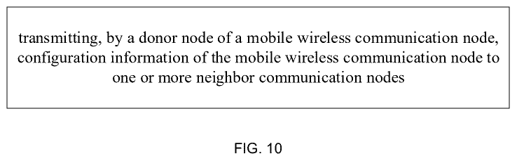

Referring to FIG. 10, in an embodiment, the communication method includes transmitting, by a donor node (e.g., a IAB donor) of a mobile wireless communication node (e.g., a mobile IAB node), configuration information of the mobile wireless communication node to one or more neighbor communication nodes (e.g., neighbor gNBs).

Details in this regard can be ascertained with reference to the paragraphs above, and will not be repeated herein.

In accordance with some embodiments, many terms used in the present disclosure may be described as below.
IAB-donor: a gNB that provides network access to UEs via a network of backhaul and access links.
IAB-donor-CU: the gNB-CU of an IAB-donor, terminating the F1 interface towards IAB-nodes and IAB-donor-DU.
IAB-donor-DU: the gNB-DU of an IAB-donor, hosting the IAB BAP (Backhaul Adaptation Protocol) sublayer, providing wireless backhaul to IAB-nodes.
IAB-DU: a gNB-DU functionality supported by the IAB-node to terminate the NR access interface to UEs and next-hop IAB-nodes, and to terminate the F1 protocol to the gNB-CU functionality, on the LAB-donor.
IAB-MT: IAB-node function that terminates the Uu interface to the parent node using the procedures and behaviors specified for UEs unless stated otherwise. IAB-MT function corresponds to IAB-UE function.
IAB-node: a RAN node that supports NR access links to UEs and NR backhaul links to parent nodes and child nodes. The IAB-node may not support backhauling via LTE.
Child node: the IAB-DU's and IAB-donor-DU's next hop neighbor node; the child node can be also an IAB-node.
Parent node: IAB-MT's next hop neighbor node; the parent node can be an IAB-node or a IAB-donor-DU.
Upstream: a direction toward a parent node in the IAB-topology.
Downstream: a direction toward a child node or a UE in the IAB-topology.

While various embodiments of the present disclosure have been described above, it should be understood that they have been presented by way of example only, and not by way of limitation. Likewise, the various diagrams may depict an example architectural or configuration, which are provided to enable persons of ordinary skill in the art to understand exemplary features and functions of the present disclosure. Such persons would understand, however, that the present disclosure is not restricted to the illustrated example architectures or configurations, but can be implemented using a variety of alternative architectures and configurations. Additionally, as would be understood by persons of ordinary skill in the art, one or more features of one embodiment can be combined with one or more features of another embodiment described herein. Thus, the breadth and scope of the present disclosure should not be limited by any one of the above-described exemplary embodiments.

It is also understood that any reference to an element herein using a designation such as “first,” “second,” and so forth does not generally limit the quantity or order of those elements. Rather, these designations can be used herein as a convenient means of distinguishing between two or more elements or instances of an element. Thus, a reference to first and second elements does not mean that only two elements can be employed, or that the first element must precede the second element in some manner.

Additionally, a person having ordinary skill in the art would understand that information and signals can be represented using any one of a variety of different technologies and techniques. For example, data, instructions, commands, information, signals, bits and symbols, for example, which may be referenced in the above description can be represented by voltages, currents, electromagnetic waves, magnetic fields or particles, optical fields or particles, or any combination thereof.

A skilled person would further appreciate that any one of the various illustrative logical blocks, units, processors, means, circuits, methods and functions described in connection with the aspects disclosed herein can be implemented by electronic hardware (e.g., a digital implementation, an analog implementation, or a combination of the two), firmware, various forms of program or design code incorporating instructions (which can be referred to herein, for convenience, as “software” or a “software unit”), or any combination of these techniques.

To clearly illustrate this interchangeability of hardware, firmware and software, various illustrative components, blocks, units, circuits, and steps have been described above generally in terms of their functionality. Whether such functionality is implemented as hardware, firmware or software, or a combination of these techniques, depends upon the particular application and design constraints imposed on the overall system. Skilled artisans can implement the described functionality in various ways for each particular application, but such implementation decisions do not cause a departure from the scope of the present disclosure. In accordance with various embodiments, a processor, device, component, circuit, structure, machine, unit, etc. can be configured to perform one or more of the functions described herein. The term “configured to” or “configured for” as used herein with respect to a specified operation or function refers to a processor, device, component, circuit, structure, machine, unit, etc. that is physically constructed, programmed and/or arranged to perform the specified operation or function.

Furthermore, a skilled person would understand that various illustrative logical blocks, units, devices, components and circuits described herein can be implemented within or performed by an integrated circuit (IC) that can include a general purpose processor, a digital signal processor (DSP), an application specific integrated circuit (ASIC), a field programmable gate array (FPGA) or other programmable logic device, or any combination thereof. The logical blocks, units, and circuits can further include antennas and/or transceivers to communicate with various components within the network or within the device. A general purpose processor can be a microprocessor, but in the alternative, the processor can be any conventional processor, controller, or state machine. A processor can also be implemented as a combination of computing devices, e.g., a combination of a DSP and a microprocessor, a plurality of microprocessors, one or more microprocessors in conjunction with a DSP core, or any other suitable configuration to perform the functions described herein. If implemented in software, the functions can be stored as one or more instructions or code on a computer-readable medium. Thus, the steps of a method or algorithm disclosed herein can be implemented as software stored on a computer-readable medium.

Computer-readable media includes both computer storage media and communication media including any medium that can be enabled to transfer a computer program or code from one place to another. A storage media can be any available media that can be accessed by a computer. By way of example, and not limitation, such computer-readable media can include RAM, ROM, EEPROM, CD-ROM or other optical disk storage, magnetic disk storage or other magnetic storage devices, or any other medium that can be used to store desired program code in the form of instructions or data structures and that can be accessed by a computer.

In this document, the term “unit” as used herein, refers to software, firmware, hardware, and any combination of these elements for performing the associated functions described herein. Additionally, for purpose of discussion, the various units are described as discrete units; however, as would be apparent to one of ordinary skill in the art, two or more units may be combined to form a single unit that performs the associated functions according embodiments of the present disclosure.

Additionally, memory or other storage, as well as communication components, may be employed in embodiments of the present disclosure. It will be appreciated that, for clarity purposes, the above description has described embodiments of the present disclosure with reference to different functional units and processors. However, it will be apparent that any suitable distribution of functionality between different functional units, processing logic elements or domains may be used without detracting from the present disclosure. For example, functionality illustrated to be performed by separate processing logic elements, or controllers, may be performed by the same processing logic element, or controller. Hence, references to specific functional units are only references to a suitable means for providing the described functionality, rather than indicative of a strict logical or physical structure or organization.

Various modifications to the implementations described in this disclosure will be readily apparent to those skilled in the art, and the general principles defined herein can be applied to other implementations without departing from the scope of the claims. Thus, the disclosure is not intended to be limited to the implementations shown herein, but is to be accorded the widest scope consistent with the novel features and principles disclosed herein, as recited in the claims below.

1. A wireless communication method, comprising:
receiving, by a mobile wireless communication node from a communication node, configuration information of the mobile wireless communication node; and
broadcasting, by the mobile wireless communication node, location information according to the configuration information.

2. The wireless communication method of claim 1, wherein the configuration information comprises at least one of:
Tracking Area Code (TAC) configuration information; or
Radio Access Network Area Code (RANAC) configuration information.

3. The wireless communication method of claim 2, wherein the TAC configuration information comprises at least one of:
one or more TACs,
a mobile IAB indication,
a TAC for a mobile IAB cell,
a dedicated TAC,
a dedicated TAC indication,
geographic location information, or
cell information.

4. The wireless communication method of claim 2, wherein the RANAC configuration information comprises at least one of:
one or more RANACs,
a mobile IAB indication,
an RANAC for a mobile IAB cell,
a dedicated RANAC,
a dedicated RANAC indication,
geographic location information, or
cell information.

5. The wireless communication method of claim 3, wherein the cell information comprises at least one of: a node identifier for the donor node connected with a parent node of the mobile wireless communication node or a cell identifier for a parent cell of the mobile wireless communication node.

6. The wireless communication method of claim 1, wherein the communication node is a parent communication node of the mobile wireless communication node or a donor node of the wireless communication node.

7. A communication method comprising:
transmitting, by a communication node to a mobile wireless communication node, configuration information of the mobile wireless communication node to allow the mobile wireless communication node to broadcasting location information according to the configuration information.

8. The wireless communication method of claim 7, wherein the configuration information comprises at least one of:
Tracking Area Code (TAC) configuration information; or
Radio Access Network Area Code (RANAC) configuration information.

9. The wireless communication method of claim 8, wherein the TAC configuration information comprises at least one of:
one or more TACs,
a mobile IAB indication,
a TAC for a mobile IAB cell,
a dedicated TAC,
a dedicated TAC indication,
geographic location information, or
cell information.

10. The wireless communication method of claim 8, wherein the RANAC configuration information comprises at least one of:
one or more RANACs,
a mobile IAB indication,
an RANAC for a mobile IAB cell,
a dedicated RANAC,
a dedicated RANAC indication,
geographic location information, or
cell information.

11. The wireless communication method of claim 9, wherein the cell information comprises at least one of: a node identifier for the donor node connected with a parent node of the mobile wireless communication node or a cell identifier for a parent cell of the mobile wireless communication node.

12. The wireless communication method of claim 7, wherein the communication node is a parent communication node of the mobile wireless communication node or a donor node of the wireless communication node.

13. The communication method of claim 7, wherein the communication node is a parent communication node of the mobile wireless communication node and receives the configuration information from a donor node of the mobile wireless communication node; or wherein the wireless communication node is a donor of the mobile wireless communication node and transmits the configuration information to a parent communication node of the mobile wireless communication node.

14. The communication method of claim 7, wherein the communication node is a donor node of the mobile wireless communication node, and the donor node transmits the configuration information to an Access and Mobility Management Function (AMF).

15. The communication method of claim 7, wherein the wireless communication node is a donor node of the mobile wireless communication node, and the donor wireless communication node transmits the configuration information to one or more neighbor communication nodes.

16. A communication method comprising:
transmitting, by a donor node of a mobile wireless communication node, configuration information of the mobile wireless communication node to an Access and Mobility Management Function (AMF), or to one or more neighbor communication nodes.

17. (canceled)

18. A wireless communication node, comprising:
a communication unit; and
a processor configured to perform the wireless communication method according to claim 1.

19. (canceled)

20. A communication node, comprising:
a communication unit; and
a processor configured to perform the wireless communication method according to claim 7.

21. (canceled)

22. A communication node, comprising:
a communication unit; and
a processor configured to: perform a communication method of claim 16.

23. A computer program product comprising a computer-readable program medium code stored thereupon, the code, when executed by a processor, causing the processor to implement a wireless communication method recited in claim 1.
